(19) United States
(12) Patent Application Publication
(10) Pub. No.: US 2022/0066538 A1
(43) Pub. Date: Mar. 3, 2022

(54) SYSTEMS AND METHODS FOR REAL-TIME ADAPTIVE USER ATTENTION SENSING

(71) Applicant: Dell Products L.P., Round Rock, TX (US)

(72) Inventors: Vivek Viswanathan IYER, Austin, TX (US); Daniel L. HAMLIN, Round Rock, TX (US)

(73) Assignee: Dell Products L.P., Round Rock, TX (US)

(21) Appl. No.: 17/009,232

(22) Filed: Sep. 1, 2020

(51) Int. Cl. G06F 3/01; G06F 21/60; G06K 9/00; G06F 11/34

(52) U.S. Cl. CPC G06F 3/011; G06F 11/3438; G06K 9/00302; G06F 21/606

(57) ABSTRACT

An information handling system may include a processor, a plurality of sensors comprising a secure camera sensor for securely communicating camera data, and a service configured to generate user awareness parameters based on data received from the plurality of sensors, apply an adaptive user presence policy to the user awareness parameters based on an adaptive user presence policy, and generate one or more actions to be executed by an operating system executing on the processor in response to the user awareness parameters and adaptive user presence policy.

### TECHNICAL FIELD

The present disclosure relates in general to information handling systems, and more particularly to systems and methods for real-time adaptive user attention sensing.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An up and coming feature on information handling systems is that of user awareness detection, sometimes referred to as attention status sensing. In general, user awareness detection may analyze features related to a user (e.g., tracking a user's face position, eye position, and gaze) to determine whether a user proximate to an information handling system is focused and attentive to a task or other information at the information handling system. Awareness detection may be used for securing access to an information handling system, aiding in maintaining a user's productivity, and/or for other uses.

One disadvantage of existing user awareness detection approaches is that detection logic and parameters are static. Accordingly, actual use cases may undesirably trigger awareness detection events (e.g., sleep state, information handling system lock), leading a user to disable user awareness detection features, this obtaining no value from such features.

### SUMMARY

In accordance with the teachings of the present disclosure, the disadvantages and problems associated with user awareness detection may be reduced or eliminated.

In accordance with embodiments of the present disclosure, an information handling system may include a processor, a plurality of sensors comprising a secure camera sensor for securely communicating camera data, and a service configured to generate user awareness parameters based on data received from the plurality of sensors, apply an adaptive user presence policy to the user awareness parameters based on an adaptive user presence policy, and generate one or more actions to be executed by an operating system executing on the processor in response to the user awareness parameters and adaptive user presence policy.

In accordance with these and other embodiments of the present disclosure, a method may include, in an information handling system comprising a plurality of sensors comprising a secure camera sensor for securely communicating camera data: generating, by a service, user awareness parameters based on data received from a plurality of sensors; applying, by the service, an adaptive user presence policy to the user awareness parameters based on an adaptive user presence policy; and generating, by the service, one or more actions to be executed by an operating system executing on the processor in response to the user awareness parameters and adaptive user presence policy.

In accordance with these and other embodiments of the present disclosure, an article of manufacture may include a non-transitory computer-readable medium and computer-executable instructions carried on the computer-readable medium, the instructions readable by a processing device, the instructions, when read and executed, for causing the processing device to, in an information handling system comprising a plurality of sensors comprising a secure camera sensor for securely communicating camera data: generate, by a service, user awareness parameters based on data received from the plurality of sensors; apply, by the service, an adaptive user presence policy to the user awareness parameters based on an adaptive user presence policy; and generate, by the service, one or more actions to be executed by an operating system executing on the processing device response to the user awareness parameters and adaptive user presence policy.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an architecture for an example system for real-time adaptive user attention sensing, in accordance with embodiments of the present disclosure;

FIG. 3 illustrates a flow chart of an example method for real-time adaptive user attention sensing, in accordance with embodiments of the present disclosure;

FIG. 4 illustrates a flow chart of an example method for training and reinforcement for real-time adaptive user attention sensing, in accordance with embodiments of the present disclosure;

FIG. 5 illustrates a table of an example machine learning with parameterization in a training phase, in accordance with embodiments of the present disclosure; and

FIG. 6 illustrates a table of an example machine learning policy adaptation in an inference and reinforcement phase, in accordance with embodiments of the present disclosure.

### DETAILED DESCRIPTION

Preferred embodiments and their advantages are best understood by reference to FIGS. 1 through 6, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

The terms “wireless transmissions” and “wireless communication” may be used to refer to all types of electromagnetic communications which do not require a wire, cable, or other types of conduits. Examples of wireless transmissions which may be used include, but are not limited to, short-range wireless communication technologies (e.g., proximity card, Radio-Frequency Identification (RFID), Near Field Communication (NFC), BLUETOOTH, ISO 14443, ISO 15693, or other suitable standard), IEEE 802.11ad (Wireless Gigabit or “WiGig”), personal area networks (PAN) (e.g., BLUETOOTH), local area networks (LAN), wide area networks (WAN), narrowband personal communications services (PCS), broadband PCS, circuit switched cellular, cellular digital packet data (CDPD), radio frequencies, such as the 800 MHz, 900 MHz, 1.9 GHz and 2.4 GHz bands, infra-red, and laser.

The term “wire-line transmissions” may be used to refer to all types of electromagnetic communications over wires, cables, or other types of conduits. Examples of such conduits include, but are not limited to, metal wires and cables made of copper or aluminum, fiber-optic lines, and cables constructed of other metals or composite materials satisfactory for carrying electromagnetic signals. Wire-line transmissions may be conducted in accordance with teachings of the present disclosure over electrical power lines, electrical power distribution systems, building electrical wiring, conventional telephone lines, Ethernet cabling (10baseT, 100baseT, etc.), coaxial cables, T-1 lines, T-3 lines, ISDN lines, ADSL, etc.

FIG. 1 illustrates a block diagram of an example information handling system 102, in accordance with embodiments of the present disclosure. In some embodiments, information handling system 102 may be a personal computer. In particular embodiments, information handling system 102 may be a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a platform controller hub (PCH) 106 communicatively coupled to processor 103, input/output devices 108 communicatively coupled to processor 103 via PCH 106, and one or more other sensors 110 communicatively coupled to processor 103 via PCH 106.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may include any system, device, or apparatus configured to retain data (including program instructions) for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

PCH 106 may be any system, device, or apparatus configured to control certain data paths (e.g., data flow between processor 103, memory 104, and peripherals) and support certain functions of processor 103. A PCH 106 may also be known as a “chipset” of an information handling system 102. For example, one such function may include implementing a management engine. A management engine may comprise hardware and/or firmware that enables remote out-of-band management for information handling system 102 in order to monitor, maintain, update, upgrade, and/or repair information handling system 102.

Each of one or more input/output (I/O) devices 108 may comprise any system, device, or apparatus configured to generate output to a user or another component and/or configured to receive input from a user or another component. Examples of I/O devices 108 may include a display, a keyboard, a mouse, an interactive touch screen, a camera, and/or associated controllers.

Each of one or more other sensors 110 may include any system, device, or apparatus configured to sense one or more physical quantities, and generate one or more signals indicative of such one or more physical quantities. An example of a sensor 110 may include a temperature sensor, an ambient light sensor, a proximity sensor, a motion sensor, a camera, and any other suitable sensor.

In addition to processor 103, memory 104, PCH 106, I/O devices 108, and other sensors 110, information handling system 102 may include one or more other information handling resources.

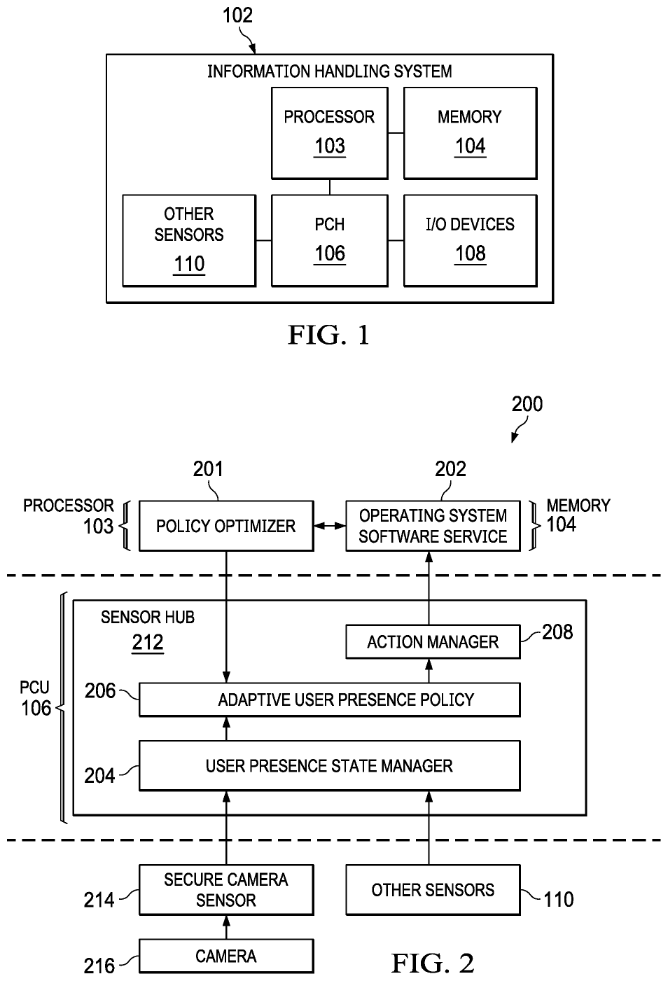

FIG. 2 illustrates an architecture for an example system 200 for real-time adaptive user attention sensing, in accordance with embodiments of the present disclosure. As shown in FIG. 2, processor 103 and memory 104 may implement a policy optimizer 201 and an operating system software service 202 that executes on top of an operating system.

Policy optimizer 201 may comprise any suitable system, device, or apparatus configured to dynamically update an adaptive user presence policy 206 based on actions performed by an action manager 208 of a sensor hub 212 and indications of whether such actions were a result of a false detection of user awareness or unawareness, as described in greater detail below.

Operating system software service 202 may comprise any suitable interface between an operating system and sensor hub 212, such that actions generated from action manager 208 (e.g., lock information handling system 102, unlock information handling system 102, etc.) may be processed by operating system software service 202 to perform such actions on the operating system of information handling system 102.

As also shown in FIG. 2, PCH 106 may include or may otherwise implement a sensor hub 212. In some embodiments, sensor hub 212 may be an integral part of an Intel Integrated Sensor Hub. As described in greater detail below, sensor hub 212 may implement a user presence state manager 204, adaptive user presence policy 206, and action manager 208.

User presence state manager 204 may be configured to receive the various conditioned sensor data from a secure camera sensor 214 and other sensors 110 and based thereon, including any relevant policy information, identify which conditioned sensor information to use to make a determination of user awareness. In essence, user presence state manager 204 may select data from an other sensor 110 or fuse data from multiple other sensors 110 to make a determination of user awareness.

Sensor hub 212 may apply an adaptive user presence policy 206 to user awareness parameters determined by user presence state manager 204 to determine if such user presence parameters indicate user awareness. Based on application of adaptive user presence policy 206 to user awareness parameters, action manager 208 may cause operating system software service 202 to perform one or more actions (e.g., lock information handling system 102 if the user is determined to not be aware; unlock information handling system 102 if the user is determined to be aware).

Secure camera sensor 214 may comprise any suitable system, device, or apparatus to receive one or more signals from a camera 216, condition such one or more signals into camera sensor parameters indicative of user awareness, and communicate such camera sensor parameters, in a secure manner, to user presence state manager 204. In some embodiments, secure camera sensor 214 may be implemented by an Intel CloverFalls microchip or similar companion microchip for control and/or sensing of camera data.

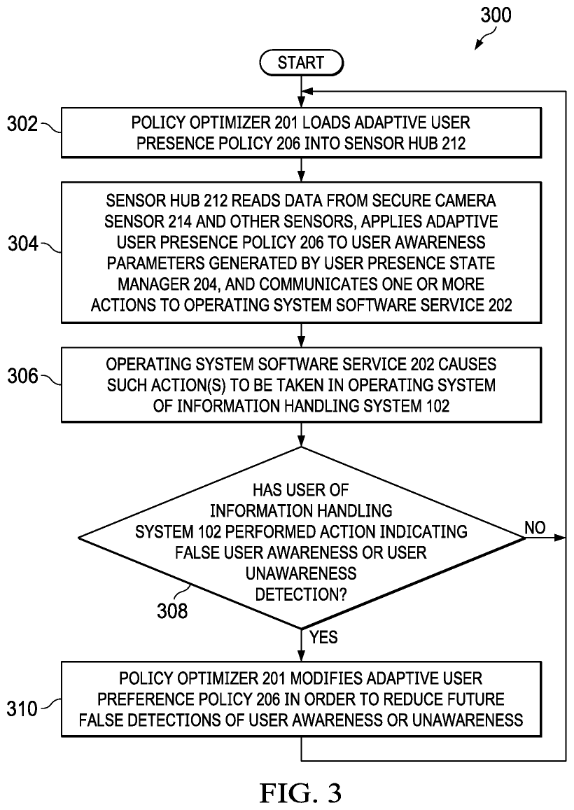

FIG. 3 illustrates a flow chart of an example method 300 for real-time adaptive user attention sensing, in accordance with embodiments of the present disclosure. According to one embodiment, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, policy optimizer 201 may load an adaptive user presence policy 206 into sensor hub 212. At step 304, sensor hub 212 may read data from secure camera sensor 214 and other sensors, apply adaptive user presence policy 206 to user awareness parameters generated by user presence state manager 204, and communicate one or more actions to operating system software service 202. At step 306, operating system software service 202 may cause such action(s) to be taken in the operating system of information handling system 102.

At step 308, policy optimizer 201 may determine if a user of information handling system 102 performed an action indicating a false user awareness or user unawareness detection. Such a user action may include any action that indicates that an action requested by action manager 208 was based on a false detection. For example, if sensor hub 212 causes information handling system 102 to lock after a false detection of user unawareness, the user may unlock information handling system 102 quickly (e.g., within seconds) after the lock event. As another example, if sensor hub 212 causes information handling system 102 to dim or sleep a display of information handling system 102 after a false detection of user unawareness, the user may quickly thereafter (e.g., within seconds) interact with an input/output device (e.g., keyboard, mouse, trackpad) of information handling system 102 to reverse the action. If policy optimizer 201 determines a user of information handling system 102 performed an action indicating a false user awareness or user unawareness detection, method 300 may proceed to step 310. Otherwise, method 300 may proceed again to step 304.

At step 310, in response to a determination that a user of information handling system 102 performed an action indicating a false user awareness or user unawareness detection, policy optimizer 201 may modify adaptive user presence policy 206 in order to reduce future false detections of user awareness or unawareness. After completion of step 310, method 300 may proceed again to step 304. Such modifications may include any suitable modification, including, without limitation:
varying of parameter thresholds for determining user unawareness;
causing adaptive user presence policy 206 to apply different rules depending on a time of day or day of week; and
causing adaptive user presence policy 206 to apply different rules depending on a physical location of information handling system 102.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using information handling system 102 or any other system operable to implement method 300. In certain embodiments, method 300 may be implemented partially or fully in software and/or firmware embodied in computer-readable media.

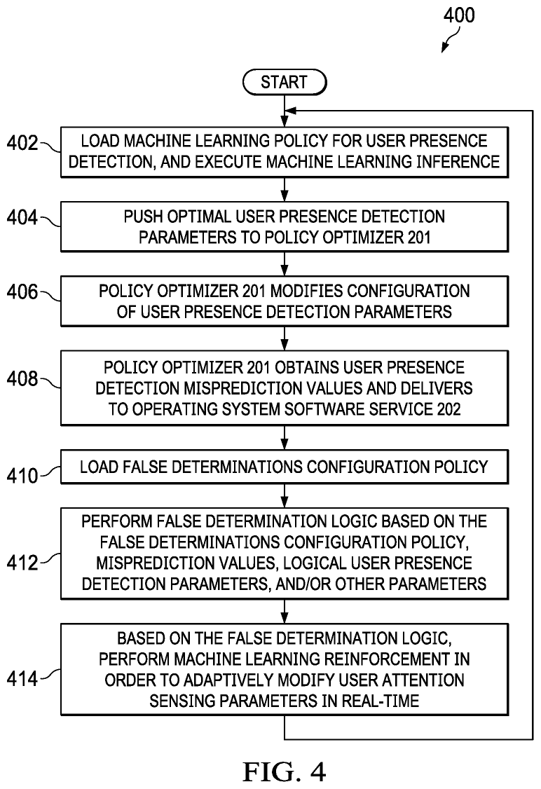

FIG. 4 illustrates a flow chart of an example method 400 for training and reinforcement for real-time adaptive user attention sensing, in accordance with embodiments of the present disclosure. According to one embodiment, method 400 may begin at step 402. As noted above, teachings of the present disclosure may be implemented in a variety of configurations of information handling system 102. As such, the preferred initialization point for method 400 and the order of the steps comprising method 400 may depend on the implementation chosen.

At step 402, operating system software service 202 may load a machine learning policy for user presence detection, and execute a machine learning inference. At step 404, operating system software service 202 may push optimal user presence detection parameters to policy optimizer 201. At step 406, policy optimizer 201 may modify a configuration of user presence detection parameters. At step 408, policy optimizer 201 may obtain user presence detection misprediction values, if any, and deliver such misprediction values to operating system software service 202.

At step 410, operating system software service 202 may load a false determinations configuration policy. At step 412, operating system software service 202 may perform false determination logic based on the false determinations configuration policy, misprediction values, logical user presence detection parameters, and/or other parameters. At step 414, based on the false determination logic, operating system software service 202 may perform machine learning reinforcement in order to adaptively modify user attention sensing parameters in real-time. After completion of step 414, method 400 may proceed again to step 402.

Although FIG. 4 discloses a particular number of steps to be taken with respect to method 400, method 400 may be executed with greater or fewer steps than those depicted in FIG. 4. In addition, although FIG. 4 discloses a certain order of steps to be taken with respect to method 400, the steps comprising method 400 may be completed in any suitable order.

Method 400 may be implemented using information handling system 102 or any other system operable to implement method 400. In certain embodiments, method 400 may be implemented partially or fully in software and/or firmware embodied in computer-readable media.

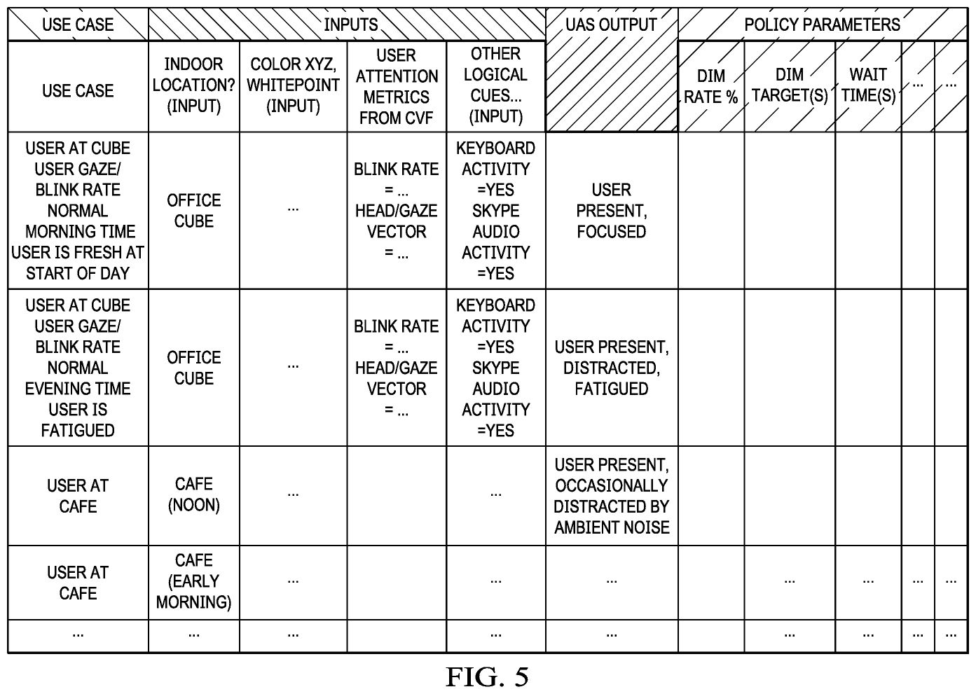

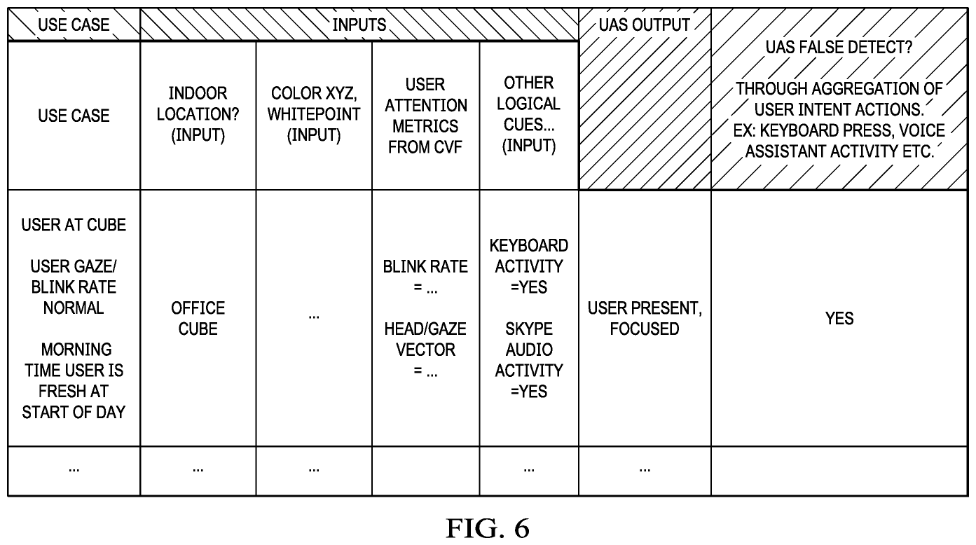

FIG. 5 illustrates a table of an example machine learning with parameterization in a training phase, in accordance with embodiments of the present disclosure. FIG. 6 illustrates aa table of an example machine learning policy adaptation in an inference and reinforcement phase, in accordance with embodiments of the present disclosure.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor;
a plurality of sensors comprising a secure camera sensor for securely communicating camera data; and
a service configured to:
generate user awareness parameters based on data received from the plurality of sensors;
apply an adaptive user presence policy to the user awareness parameters based on an adaptive user presence policy; and
generate one or more actions to be executed by an operating system executing on the processor in response to the user awareness parameters and adaptive user presence policy.

2. The information handling system of claim 1, wherein the service is implemented by a sensor hub implemented by a platform controller hub interfaced between the processor and the plurality of sensors.

3. The information handling system of claim 1, further comprising a policy optimizer configured to execute on the operating system and configured to:
determine if the one or more actions result from a false user awareness detection; and
if the one or more actions result from a false user awareness detection, update the adaptive user presence policy to reduce future occurrences of false user awareness detection.

4. A method comprising, in an information handling system comprising a plurality of sensors comprising a secure camera sensor for securely communicating camera data:
generating, by a service, user awareness parameters based on data received from a plurality of sensors;
applying, by the service, an adaptive user presence policy to the user awareness parameters based on an adaptive user presence policy; and
generating, by the service, one or more actions to be executed by an operating system executing on the processor in response to the user awareness parameters and adaptive user presence policy.

5. The method of claim 4, wherein the service is implemented by a sensor hub implemented by a platform controller hub interfaced between the processor and the plurality of sensors.

6. The method of claim 4, further comprising:
determining, by a policy optimizer configured to execute on the operating system, if the one or more actions result from a false user awareness detection; and
if the one or more actions result from a false user awareness detection, updating, by the policy optimizer, the adaptive user presence policy to reduce future occurrences of false user awareness detection.

7. An article of manufacture comprising:
a non-transitory computer-readable medium; and
computer-executable instructions carried on the computer-readable medium, the instructions readable by a processing device, the instructions, when read and executed, for causing the processing device to, in an information handling system comprising a plurality of sensors comprising a secure camera sensor for securely communicating camera data:
generate, by a service, user awareness parameters based on data received from the plurality of sensors;
apply, by the service, an adaptive user presence policy to the user awareness parameters based on an adaptive user presence policy; and
generate, by the service, one or more actions to be executed by an operating system executing on the processing device response to the user awareness parameters and adaptive user presence policy.

8. The article of claim 7, wherein the service is implemented by a sensor hub implemented by a platform controller hub interfaced between the processing device and the plurality of sensors.

9. The article of claim 7, the instructions for further causing the processing device to:
determine, by a policy optimizer configured to execute on the operating system, if the one or more actions result from a false user awareness detection; and
if the one or more actions result from a false user awareness detection, update, by the policy optimizer, the adaptive user presence policy to reduce future occurrences of false user awareness detection.
